(19) United States
(12) Patent Application Publication
(10) Pub. No.: US 2008/0180519 A1
(43) Pub. Date: Jul. 31, 2008

(54) PRESENTATION CONTROL SYSTEM

(76) Inventor: Ronald S. Cok, Rochester, NY (US)

Correspondence Address: Frank Pincelli;Patent Legal Staff, Eastman Kodak Company, 343 State Street, Rochester, NY, 14650-2201, US

(21) Appl. No.: 11/669,482

(22) Filed: Jan. 31, 2007

(51) Int. Cl. H04N 7/14; G10L 11/00

(52) U.S. Cl. 348/14.02; 704/275; 348/E07.078

(57) ABSTRACT

A communication system is disclosed that is under the control of a presenter for providing audio and visual information at a first site and a second remote site. Such system includes at least one image generation device for generating one or a plurality of images at the first site, a transmitter for transmitting the generated image to the second site, a display device at the second site for displaying the transmitted image, and a command capture device response responsive to a command of a presenter at the first site for controlling the transmission of a selected image by the transmitter.

### FIELD OF THE INVENTION

The present invention relates to a system for controlling presentations by a presenter at a first location and at a second location remote from the first location.

### BACKGROUND OF THE INVENTION

Two-way video systems are available that include a display and camera in each of two locations connected by a communication channel that allows communication of video images and audio between two different sites. Originally, such systems relied on setup at each site of a video monitor to display a remote scene and a separate video camera, located on or near the edge of the video monitor, to capture a local scene, along with microphones to capture the audio and presenters to present the audio thereby providing a two-way video and audio telecommunication system between two locations.

Referring to FIG. 5, a typical prior art two-way telecommunication system is shown wherein a first viewer 71 views a first display 73. A first image capture device 75, which can be a digital camera, captures an image of the first viewer 71. If the image is a still digital image, it can be stored in a first still image memory 77 for retrieval. A still image retrieved from first still image memory 77 or video images captured directly from the first image capture device 75 will then be converted from digital signals to analog signals using a first D/A converter 79.

A first modulator/demodulator 81 then transmits the analog signals using a first communication channel 83 to a second display 87 where a second viewer 85 may view the captured image(s).

Similarly, second image capture device 89, which can be a digital camera, captures an image of second viewer 85. The captured image data is sent to a second D/A converter 93 to be converted to analog signals but can be first stored in a second still image memory 91 for retrieval. The analog signals of the captured image(s) are sent to a second modulator/demodulator 95 and transmitted through a second communication channel 97 to the first display 73 for viewing by first viewer 71.

Although such systems have been produced and used for teleconferencing and other two-way communication applications, there are some significant practical drawbacks that have limited their effectiveness and widespread acceptance. Expanding the usability and quality of such systems has been the focus of much recent research, with a number of proposed solutions directed to more closely mimic real-life interaction and thereby creating a form of interactive virtual reality. A number of these improvements have focused on communication bandwidth, user interface control, and the intelligence of the image captures and display component of such a system. Other improvements seek to integrate the capture device and display to improve the virtual reality environment.

One problem faced by modern communication systems is the variety of information and imagery present in many remote interactions between two groups of people at two different sites. Typical systems at each site are connected by an intercommunication system that relies upon a single camera at each site, a display for viewing the locally captured and transmitted image and a separate display for viewing the remotely captured and received image. Typically, each group of people operate a local camera and an image of the group is sent from each site to the other remote site. The camera can be set at a wide angle to capture images of the entire group or can be zoomed in on one group member or a subset of group members. Such communication systems often include a second camera mounted on a stand for capturing images on paper or other relatively planar materials. By employing a control device, the group can select the imagery to be transmitted. Such systems are often cumbersome and ineffective.

Methods for automating the video-conference experience to make such experiences are described in the literature. For example, WO2002047386 A1 entitled “Method and Apparatus for Predicting Events in Video Conferences and Other Applications” describes predicting events using acoustic and visual commands. Audio and video information is processed to identify one or more acoustic commands, such as intonation patterns, pitch and loudness, visual commands, such as gaze, facial pose, body postures, hand gestures and facial expressions, or a combination of the foregoing, that are typically associated with an event, such as behavior exhibited by a video conference participant before he or she speaks. However, such a system is very complex. It can be very participant dependent and requires a learning mode to develop a characteristic profile of each participant.

Other systems employ camera-based gesture input to control computer-generated graphics. For example, WO1999034327 A2 entitled “System and Method for Permitting Three-Dimensional Navigation through a Virtual Reality Environment using Camera-based Gesture Input” describes a system and method for permitting three-dimensional navigation through a virtual reality environment using camera-based gesture inputs of a system user. The system comprises a computer-readable memory, a video camera for generating video signals indicative of the gestures of the system user and an interaction area surrounding the system user, and a video image display. The system further comprises a microprocessor for processing the video signals, in accordance with a program stored in the computer-readable memory, to determine the three-dimensional positions of the body and principle body parts of the system user. The microprocessor constructs three-dimensional images of the system user and interaction area on the video image display based upon the three-dimensional positions of the body and principle body parts of the system user. The video image display shows three-dimensional graphical objects within the virtual reality environment, and movement by the system user permits apparent movement of the three-dimensional objects displayed on the video image display so that the system user appears to move throughout the virtual reality environment.

Another system for controlling cameras in a system is described in U.S. Pat. No. 6,992,702 B1 entitled “System for controlling video and motion picture cameras” which describes a camera view directed toward a location in a scene based on drawn inputs. Such systems can be unnatural to a user and require training as well as the provision of a control surface and tokens.

The proliferation of solutions proposed for improved teleconferencing and other two-way video communication shows how complex the problem is and indicates that significant problems remain. Thus, it is apparent that there is a need for a simpler, more flexible, and capable system that improves two-way communication, adapts to different fields of view and image sources, and desired changes in transmitted content.

### SUMMARY OF THE INVENTION

In accordance with this invention a communication system under the control of a presenter for providing audio and visual information at a first site and a second remote site, comprising:

a) at least one image generation device for generating one or a plurality of images at the first site;

b) a transmitter for transmitting the generated image to the second site;

c) a display device at the second site for displaying the transmitted image; and

d) a command capture device response responsive to a command of a presenter at the first site for controlling the transmission of a selected image by the transmitter.

### BRIEF DESCRIPTION OF THE DRAWINGS

In the detailed description of the preferred embodiments of the invention presented below, reference is made to the accompanying drawings in which:

FIG. 1 is a block diagram of an embodiment of the present invention employing audio commands;

FIG. 2 is a block diagram of an audio system useful for recognizing audio commands;

FIG. 3 is an illustration of a presenter employing audio commands;

FIG. 4 is an illustration of a presenter employing gesture commands; and

FIG. 5 is a block diagram of a typical prior art telecommunication system.

### DETAILED DESCRIPTION OF THE INVENTION

The apparatus and method of the present invention address the need for a user-friendly, multi-mode communication transmission system. Such a system transmits information from a variety of sources to a remote location for observation. In particular, a variety of image sources are employed to clearly communicate a message. Images from the variety of sources are selected by a presenter using presenter commands, and transmitted to the remote location for observation by a remote person.

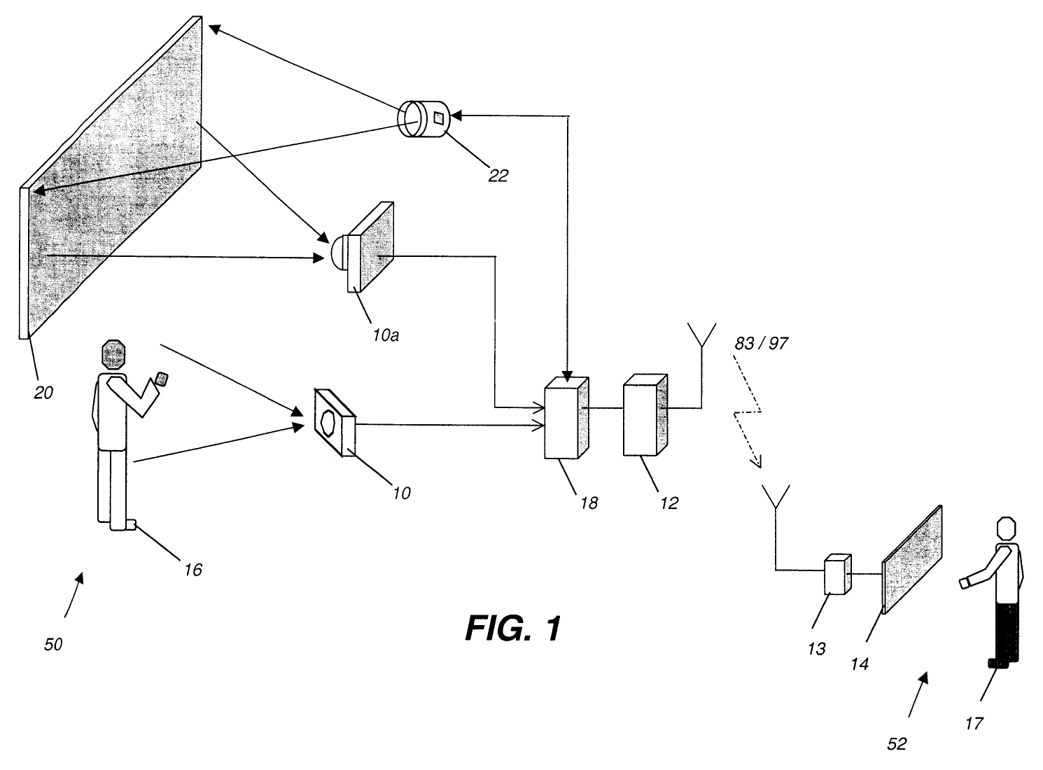

Referring to FIG. 1 in one embodiment of the present invention, a communication system under the control of a presenter for providing audio and visual information at a first site 50 and a second remote site 52, comprises at least one image generation device 10 for generating one or a plurality of images at the first site 50, a transceiver 12 for transmitting at least one of the generated images to the second site 52, a display device 14 at the second site 52 for displaying the transmitted image; and a command capture and system control device 18 responsive to a command of a presenter 16 at the first site 50 for controlling the transmission of a selected image by the transceiver 12. A transceiver 13 employed to receive the transmitted image at the second site 52 and a viewer 17 in an audience at the second site 52 can view the transmitted image on the display device 14.

In the embodiment of FIG. 1, a first digital camera 10 captures images of a presenter 16. The presenter 16 controls whether the image captured by the first digital camera 10 or whether another captured or generated image is selected to be viewed at the first and second sites 50 and 52 respectively. The command capture device is an automated system for recording the presenter commands, analyzing the commands to recognize the command instruction, and controlling the selected image transmission in response to the recognized command. Commands may take a variety of forms, for example, including audio such as verbal commands and including visual commands such as gesture commands.

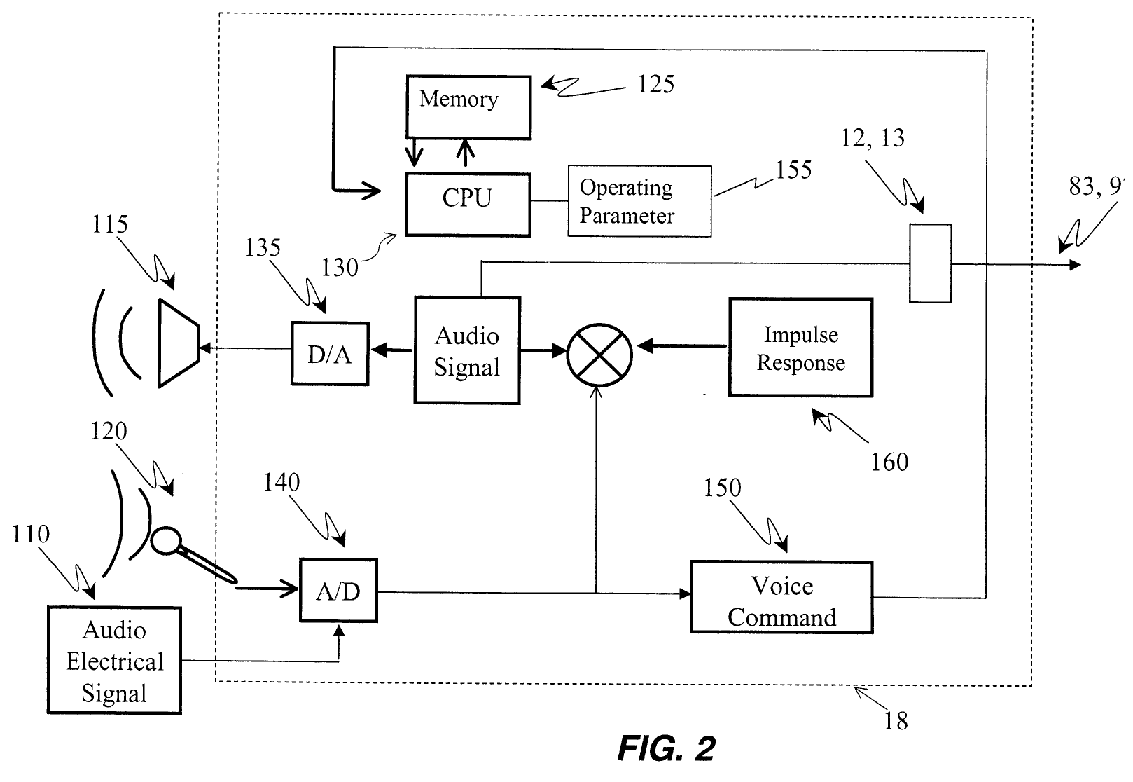

In a typical presentation to a group audience, a presenter 16 can employ a display screen 20 on which is projected information by a projector 22 under the control of the command capture and system control device 18. The presenter typically employs spoken words and gestures to communicate. Aural and visual commands can be readily interspersed between such words and gestures. Since most presentation venues employ electronic audio amplification systems to improve the volume of the speaker's voice, an aural command recognition system, (such as is illustrated in FIG. 2) can be readily integrated into the amplification system without disturbing the presenter's ability to communicate audibly. Such an integrated amplification and command recognition system can comprise, for example, microphones 120, speakers 115, CPU 130, and memory 125. The microphone receives sound from a presenter 16, and converts it to a digital signal by employing an A/D converter 140. The sound is amplified, passed through a D/A converter 135 and emitted from speakers 115. Simultaneously, the signal is transferred to a transceiver 12 and communicated through a communication channel 83 to a remote, second site 52. The signal is also analyzed by the computer 130 to detect commands that, when detected, causes the system 18 to switch image sources (FIG. 1). Local audience members readily adjust their attention from the presenter to the projected information, depending on the context. However, in situations in which a portion of the audience can be remote, a single display is typically provided at the remote site and only a single image presented on the display. Such a limitation can decrease the remote portion of the audience's ability to comprehend the presenter's communication. Hence, by selecting one of a plurality of image sources to be communicated to the remote site under the direction of a presenter, the present invention improves communication to the remote audience.

Projector 22, display screen 20, transceivers 12, 13, display 14, and cameras 10, 10a, are all known in the art and commercially available. Command recognition systems 18 can employ microphones for recording a presenter's speech attached to audio digitization equipment or digital cameras that image the presenter. The audio information can be analyzed by voice recognition or speech recognition software intended to excerpt specific command (e.g. words or phrases) to identify a command. Likewise, digital images, or streams of digital images, can be analyzed by image processing software to identify gestures representing specific visual command (e.g. pointing by a hand). Such software is known in the art. In other embodiments of the present invention, a combination of audio and visual command can be employed to reduce the possibility of error, for example in noisy environments.

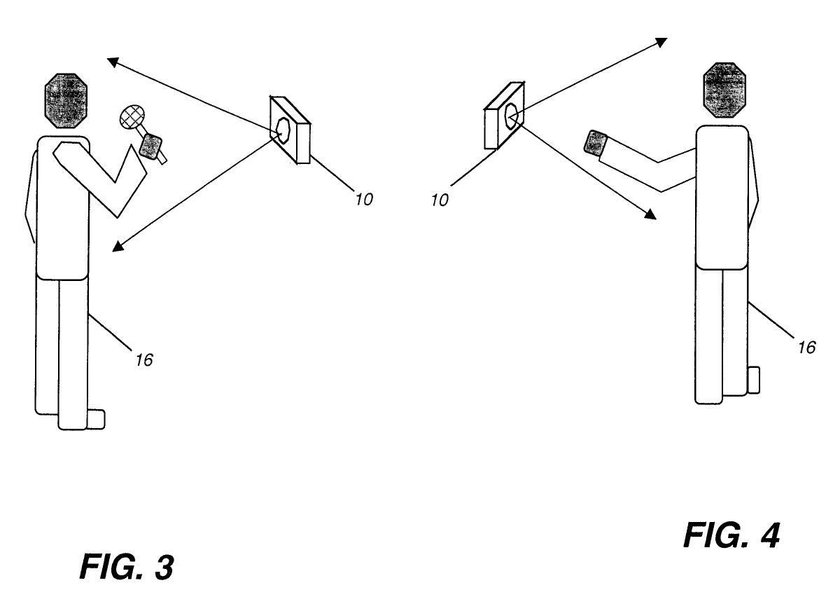

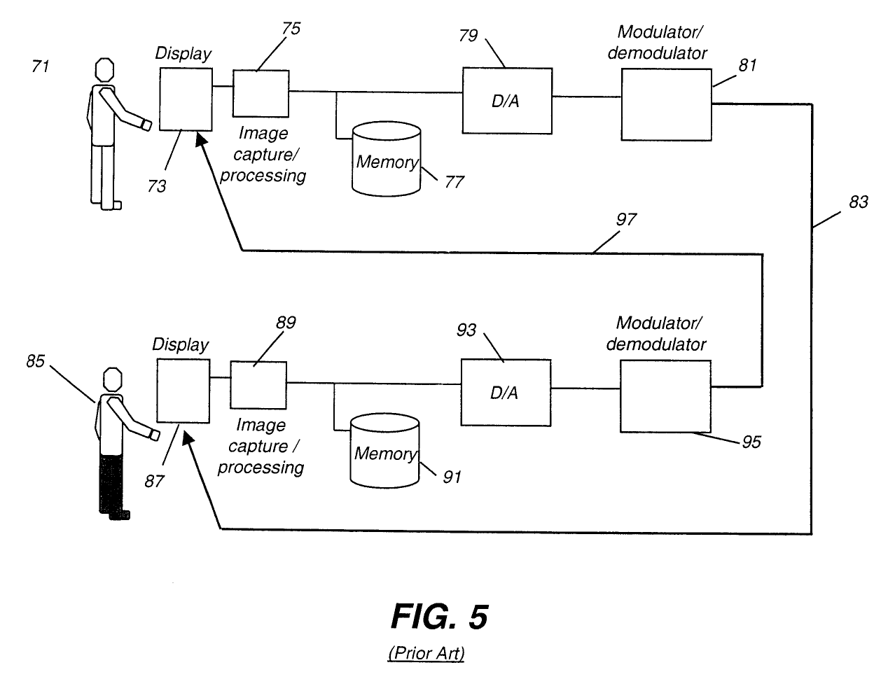

FIG. 2 depicts the components of an audio system 175 useful for providing command recognition of audio commands and for providing a public address system for a presenter to address an audience. FIG. 3 illustrates a presenter 16 employing a microphone 120 to provide audio input. In the embodiment of FIG. 2, the audio device 175 also provides an audio electrical signal 110 that can amplify the presenter's voice. The audio signal could also be from other sources, such as a recording or an Internet connection. In particular the electrical signal may embody a voice command 150. A CPU 130 can be employed to analyze the voice command 150 and a memory 125 can be employed to store the signal and can also contain a computer program executed by the CPU 130 using optional operating parameters 155. The memory 125 can for example be a random access memory or a serial access memory that can also be used for other purpose. The invention may use computer programs, and in such case some form of memory that maintains its contents when the audio system is turned off is desirable. Using wireless technology, it is understood that many of the components depicted in FIG. 2 could be housed outside of the audio emission device 175. For example, the CPU 130 and memory 125 could be housed by a personal computer that communicates commands via a wireless protocol. The audio system 175 may also employ noise reducing techniques, for example by storing the audio impulse response 160 of the chamber in which the presenter is speaking to reduce echo or undesired positive amplification feedback.

The voice command 150 can have a thresholding operation to eliminate low amplitude extraneous sounds occurring in the room or elsewhere. Enough memory should be provided to store the longest (in time) voice command expected by the user. 512 kilobytes is sufficient for most applications. A running average square and sum of the signal values can be stored in the memory 125. This running sum is tested against a threshold. When the running sum is lower than a constant threshold, successive values contained in the memory are discarded. This threshold can be best determined empirically within the design process of the audio emission device because of the variation of the microphone gains due to design and other considerations. To determine a reasonable threshold, it is recommended that the average squared sum of the signal values be calculated for a typical persons' utterance of a command lasting 1 second at a normal conversation amplitude level.

In the case wherein a voice command is present, the average summed square of the voice command signal is larger than the threshold. In this case, the CPU 130 analyzes the voice command. This data needs to be interpreted by the CPU 130 and memory 125 in order to recognize an operating parameter 155 (for example, from a list of pre-determined commands). The interpretation of the voice command resides in the field of speech recognition. It is appreciated that this field is extremely rich in variety in that many different algorithms can be used. In one embodiment, the presenter can prefix every command with the word “command” in order to filter out ordinary conversation occurring near the audio emitting device. That is, if one wants to change the selected image, a presenter could state the phrase “command channel one”, for example. The CPU 130 can search for the word “command” to eliminate extraneous sounds or conversations from interpretation. Next it interprets the word “channel” which in turn signals the expectation of the word “one” or “two”. In the present case the word “one” can be a command that causes the CPU 130 to switch the selected image source.

Using the prefix “command” for voice commands can be shown to decrease the sophistication of the CPU 130 needed to interpret the voice commands. As speech recognition technologies improve, it is expected that this advantage can be reduced. Many companies presently provide speech interpretation software and hardware modules. One such company is Sensory Inc. located at 1500 NW 18^{th} Avenue, in Portland Oreg. The components of an audio system 175 are known in the art.

In an alternative embodiment of the present invention, a gesture recognition system may be employed. Referring to FIG. 4, a presenter 16 gestures in front of a camera 10 that captures images of the presenter 16. As shown in FIG. 1, the images of the speaker are analyzed by a command recognition system, for example an image processing system to recognize gestures as commands and act accordingly. Such image capture, image processing, and image analysis and understanding software are known in the art. The commands may be combinations of audio and video, for example by combining verbal expressions with gestures to form commands.

The presenter can employ verbal and visual commands to an automated command recognition system. Depending on the command, the automated command recognition system can select the desired image for transmission. For example, a presenter can first provide a command directing the communication system to transmit an image of himself or herself. When fresh information is presented on a display screen, the presenter can employ a different command to direct the communication system to transmit an image of the screen. In some embodiments of the present invention, the commands may change the appearance of the information, for example enlarging a portion of the information, changing the volume of an audio feed, outlining, or changing the speed of a video playback. In other embodiments, a plurality of cameras are employed with other image recording devices, for example digital microscopes, images of a local group of people such as an audience, computer-generated imagery, or even remote cameras recording images of remote content. Such images can be interwoven into a stream of information useful to a remote audience by employing command provided by the presenter.

Images may be computer generated, for example information presentation such as text documents, spreadsheets, or computer generated imagery, for example artificial representations of one or more persons. Such images may be interwoven into a stream of information useful to a remote audience by employing commands provided by the presenter. The computer may serve to generate artificial images or graphics that can be directly employed without a separate camera 10a. The computer may provide graphic representations of actual people or artificial (computer generated) person representations, for example as an avatar, in either still or motion form, in real time or in a recording, and interactively. In other embodiments of the present invention, the commands may change the appearance of the information, for example enlarging a portion of an image, changing the volume of a recording, speed of playback (slow motion or accelerated motion), outlining portions of text, and so forth.

In other embodiments of the present invention, a presenter controlling the system and providing commands can be a separate person from a speaker. A second camera 10a captures images of a display screen 20 on which the presenter illustrates information projected on the display screen 20 by a projector 22.

According to another embodiment of the present invention, a remote site can be, for example, a very large arena or stadium where audience members close to the presenter can observe the presenter and display screen directly while those audience members far from the presenter must rely upon a large, separate display.

The presenter commands can control the operation of a camera. For example, an instruction to zoom or pan can be provided in response to a command and the image captured by the camera is modified in response. In particular, a camera can be employed to switch between close-ups of one or a few people or other elements in a scene and a wide-angle view of a larger group or a scene. In other embodiments of the present invention, an image processing system can be employed to integrate two or more captured images into a single transmitted image in response to a presenter command. Hence, a presenter can interactively control the nature of the images transmitted as well as selecting from a variety of image sources.

Although the embodiment of the present invention illustrated in FIG. 1 shows a single presenter and command recognition system, such a system can be likewise employed at one or more remote sites, to provide an interactive telecommunication system. For example, the present invention can incorporate a display at the first site for displaying images captured at the second site and transmitted to the first site. More generally, one or more cameras for capturing at least one image of one of a plurality of scenes at the second site, can be provided together with a transmitter for transmitting the capture image to the first site, a display device at the first site for displaying the transmitted image, a presenter at the second site for controlling the transmitted image by employing commands, a command-recognition system responsive to presenter commands for selecting at least one of the scenes for capture and transmission. It is possible that some of the cameras or displays may be mobile. In the case in which an interaction between sites is desired, two presenters may be present and can, through commands, transfer control of the system from one presenter to the other.

In other embodiments of the present invention useful for smaller groups, the display can incorporate one or more image-capture devices, for example at the edges or corner of the display or located behind the display. Such integrated display-and-image-capture systems are known in the art. For example, OLED devices, because they use thin-film components, can be fabricated to be substantially transparent, as has been described in the article “Towards see-through displays: fully transparent thin-film transistors driving transparent organic light-emitting diodes,” by Gornn et al., in Advanced Materials, 2006, 18(6), 738-741.

The communication system of the present invention has potential application for teleconferencing or video telephony. The transmitted image content can include photographic images, animation, text, charts and graphs, diagrams, still and video materials, live images of humans speaking, individually or in groups, and other content, either individually or in combination.

The invention has been described in detail with particular reference to certain preferred embodiments thereof, but it will be understood that variations and modifications can be effected within the spirit and scope of the invention. It should be understood that the various drawing and figures provided within this invention disclosure are intended to be illustrative and are not to scale engineering drawings.

### Parts List

10 camera
10a camera
12 transceiver
13 transceiver
14 display
16 presenter
17 viewer
18 command-recognition system
20 display screen
22 projector
50 first site
52 second site
71 first viewer
73 first display
75 first image capture device
77 first still image memory
79 first D/A converter
81 first modulator/demodulator
83 first communication channel
85 second viewer
87 second display
89 second image capture device
90 control logic processor
91 second still image memory
93 second D/A converter
95 second modulator/demodulator
110 audio electrical signal
115 speaker
120 microphone
125 memory
130 CPU
135 D/A converter
150 voice command
155 operating parameters
160 impulse response
175 audio system

1. A communication system under the control of a presenter for providing audio and visual information at a first site and a second remote site, comprising:
a) at least one image generation device for generating one or a plurality of images at the first site;
b) a transmitter for transmitting the generated image to the second site;
c) a display device at the second site for displaying the transmitted image; and
d) a command capture device response responsive to a command of a presenter at the first site for controlling the transmission of a selected image by the transmitter.

2. A communication system under the control of a presenter for providing audio and visual information at a first site and a second remote site, comprising:
a) at least one image generation device for generating at least one of a plurality of images at the first site;
b) a transmitter for transmitting the generated image and audio information produced by the presenter to the second site;
c) a display device at the second site for displaying the transmitted image; and
d) a command capture device responsive to audio commands by the presenter for recognizing such commands and, in response thereto, controlling the transmission of a selected image by the transmitter.

3. A communication system under the control of a presenter for providing audio and visual information at a first site and a second remote site, comprising:
a) at least one image generation device for generating at least one of a plurality of images at the first site;
b) a transmitter for transmitting the generated image to the second site;
c) a display device at the second site for displaying the transmitted image;
d) a command capture device for capturing a visual image of the presenter and for recognizing gestures of the presenter as representing a command and responsive to such command for controlling the transmission of a selected image by the transmitter; and
e) a command-recognition system responsive to presenter commands for selecting at least one of the scenes for capture and transmission.

4. The communication system of claim 3 wherein the command are visual command.

5. The communication system of claim 4 wherein the visual command are gesture signals.

6. The communication system of claim 3 wherein the command are audio signals.

7. The communication system of claim 6 wherein the audio signals are words or phrases.

8. The communication system of claim 3 wherein the command are combinations of audio and visual signals.

9. The communication system of claim 3 wherein the scenes include a view of the presenter, a view of a display screen, or a view of a group of people.

10. The communication system of claim 3 wherein one of the plurality of scenes is an image of a person.

11. The communication system of claim 10 wherein the person is the presenter.

12. The communication system of claim 3 wherein the one or more cameras include a first camera oriented to capture an image of a person and a second camera oriented to capture an image of a display screen.

13. The communication system of claim 3 wherein the one or more cameras include a first camera with a scene selection device for controlling the camera to capture the selected scene.

14. The communication system of claim 3 wherein at least one camera pans or zooms in response to a presenter command.

15. The communication system of claim 3 further comprising a display at the first site for displaying images captured at the second site and transmitted to the first site.

16. The communication system of claim 12 wherein the display incorporates one or more image-capture devices.

17. The communication system of claim 12 wherein the command recognition system is an automated computer system.

18. The communication system of claim 3, further comprising an image processing system for integrating two or more captured images into a single transmitted image in response to a presenter command.

19. The communication system of claim 3, wherein one of the plurality of scenes is a wide-angle version of another of the scenes.

20. The communication system of claim 3, further comprising:
a) an image generation device for generating at least one of a plurality of images at the second site;
b) a transmitter for transmitting the capture image to the first site;
c) a display device at the first site for displaying the transmitted image; and
d) a command capture device response responsive to a command of a second presenter at the second site for controlling the transmission of a selected image by the transmitter.
